(19) United States
(12) Patent Application Publication
(10) Pub. No.: US 2017/0293311 A1
(43) Pub. Date: Oct. 12, 2017

(54) TEMPERATURE CONTROL SYSTEMS

(71) Applicant: Goodrich Corporation, Charlotte, NC (US)

(72) Inventor: William Rappoport, Danbury, CT (US)

(21) Appl. No.: 15/096,390

(22) Filed: Apr. 12, 2016

(51) Int. Cl. G05D 23/19; H04B 3/54; G05B 15/02

(52) U.S. Cl. CPC G05D 23/19; G05B 15/02; H04B 3/548

(57) ABSTRACT

A temperature control system includes a central control system including a central controller that outputs a temperature command signal, and a DC power source configured to output a DC power, wherein the central control system is configured to combine the DC power with temperature command signals to output a modulated power signal on a power line.

### BACKGROUND

### 1. Field

The present disclosure relates to sensor systems, more specifically to temperature control systems.

### 2. Description of Related Art

Many types of systems require distributed heaters to maintain constant temperature across an extended volume despite non-uniform and changing thermal environments. In large thermally controlled systems, many temperature sensors are required to sense local temperatures and control heaters, and to provide temperature information back to a central temperature reporting and control system. Cabling is required to provide power to the heater, and separate wires are required to bring back the temperature information. In physically large systems, with long cable runs, the amount of wiring may be substantial. In some weight critical systems, such as large space satellites, it is desirable to reduce the cabling weight.

Such conventional methods and systems have generally been considered satisfactory for their intended purpose. However, there is still a need in the art for improved temperature control systems. The present disclosure provides a solution for this need.

### SUMMARY

A temperature control system includes a central control system including a central controller that outputs a temperature command signal, and a DC power source configured to output a DC power, wherein the central control system is configured to combine the DC power with temperature command signals to output a modulated power signal on a power line.

The central control system can further include a data formatter operatively connected to the central controller and configured to convert the temperature command signal from the central controller to a serial digital format using a modulation frequency to create modulated serial data.

The central control system can further include a reference clock operatively connected to the data formatter, wherein the modulation frequency can be controlled by the reference clock. The central control system can further include a transmit amplifier coupled to the data formatter to output the temperature sensor signal onto the power line via a transmit capacitor.

The central control system can further include an isolation inductor disposed between the transmit capacitor and the DC power source for isolating the temperature command signal from the DC power source. The central control system can further include a receiving interface to receive data from the power line.

The temperature control system can include one or more heater control systems connected to the central control system via the power line. Each heater control system can include a local controller configured to receive the temperature command signal from the modulated signal, and a heater switch controlled by the local controller to selectively electrically connect a heater to the power line, wherein the local controller controls the heater switch based on the temperature command signal. In certain embodiments, the one or more heater control systems can include one or more temperature sensors coupled to the local controller to provide temperature feedback to the local controller.

In certain embodiments, the temperature command signal can include at least one of temperature set point command or a data transmit command. The temperature command signal can include an address code which addresses the temperature command signal to one or more of the heater control systems.

The one or more heater control systems can include a receiver that is disposed between the local controller and the power line, wherein the receiver is coupled to the power line via a receiver capacitor to receive the temperature command signal and output it to the local controller. Each heater control system can include a band pass filter connected between the receiver and the receiver capacitor to pass the modulation frequency and reject other transient frequencies.

In certain embodiments, the local controller can include a digital module that searches for the address in the temperature command signal that corresponds to an associated heater controlled by the local controller, wherein the digital module decodes the temperature command signal if the address corresponds to the associated heater.

The one or more heater control systems can include a sensor excitation source and digitization electronics. Each heater control system can include a local voltage regulator coupled between to the power line and at least one of the local controller or the sensor excitation source to convert power from the power line to a useable form.

The local controller can be configured to transmit temperature sensor data back to the central control system via the power line using a local transmitter to modulate the DC power on the power line. The receiver interface of the central control system can include a receiver capacitor and a band pass filter disposed between the power line and the central controller to filter the temperature sensor data from the DC power.

A heater control system can be configured to be connected to a central control system via a power line can include a local controller configured to receive a temperature command signal from a modulated signal on the power line, and a heater switch controlled by the local controller to selectively electrically connect a heater to the power line, wherein the local controller controls the heater switch based on the temperature command signal.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic diagram of an embodiment of a system in accordance with this disclosure.

### DETAILED DESCRIPTION

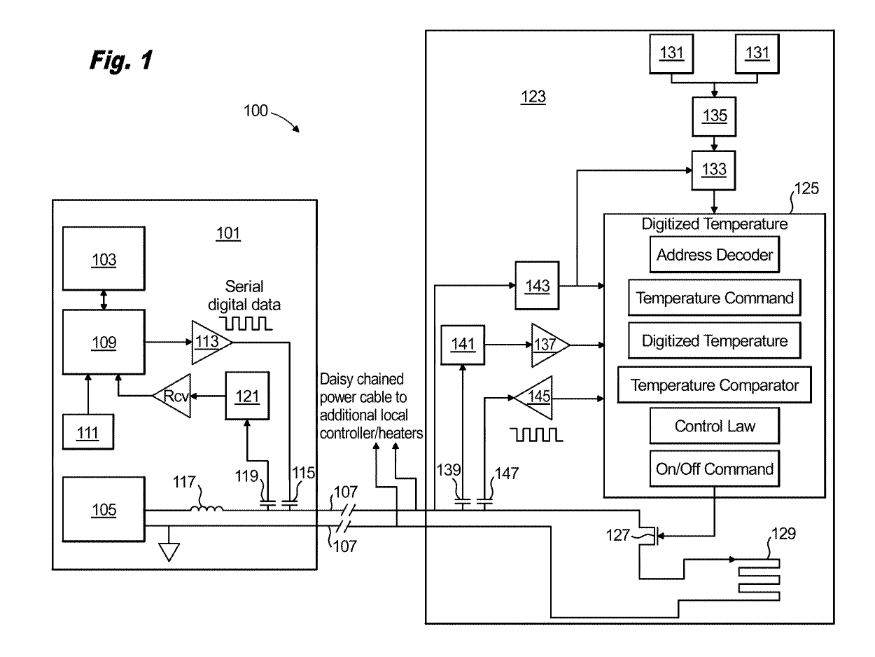

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. The systems and methods described herein can be used to reduce size and/or weight of temperature control systems (e.g., for aircraft, spacecraft, and/or satellites).

Referring to FIG. 1, a temperature control system 100 includes a central control system 101 including a central controller 103 that outputs a temperature command signal. The central control system 101 also includes a DC power source 105 configured to output a DC power. The central control system 101 is configured to combine the DC power with temperature command signals to output a modulated power signal on a power line 107.

The central control system 101 can further include a data I/0 formatter 109 operatively connected to the central controller 103 and configured to convert the temperature command signal from the central controller 103 to a serial digital format using a modulation frequency to create modulated serial data (e.g., in a modulation format such as On/Off Keying).

The central control system 101 can further include a reference clock 111 operatively connected to the data formatter 109. The modulation frequency of the temperature control signal can be controlled by the reference clock 111.

The central control system 101 can further include a transmit amplifier 113 coupled to the data formatter 109 to output the temperature sensor signal onto the power line 107 via a transmit capacitor 115. In certain embodiments, the central control system 101 can include an isolation inductor 117 disposed between the transmit capacitor 115 and the DC power source 105 for isolating the temperature command signal from the DC power source 105.

The central control system 101 can further include a receiving interface to receive data from the power line 107. The receiver interface of the central control system 101 can include a receiver capacitor 119 and a band pass filter 121 disposed between the power line 107 and the central controller 103 to filter temperature sensor data and/or any other suitable data from the DC power on the power line 107.

The temperature control system 100 can include one or more heater control systems 123 connected to the central control system 101 via the power line 107. Each heater control system 123 can include a local controller 125 configured to receive the temperature command signal from the modulated signal on the power line 107. A heater switch 127 is controlled by the local controller 125 to selectively electrically connect a heater 129 to the power line 107. The local controller 125 can control the heater switch 127 based on the temperature command signal.

In certain embodiments, the one or more heater control systems 123 can include one or more temperature sensors 131 coupled to the local controller 125 to provide temperature feedback to the local controller 125. The one or more heater control systems 123 can include a sensor excitation source and digitization electronics (e.g., an exciter and analog to digital converter in block 133). A plurality of temperature sensors 131 can be connected to the sensor excitation source and/or the digitization electronics via a multiplexor 135.

The one or more heater control systems 123 can include a receiver 137 that is disposed between the local controller 125 and the power line 107. The receiver 137 can be coupled to the power line 107 via a receiver capacitor 139 to receive the temperature command signal and output it to the local controller 125. The heater control system 123 can include a band pass filter 141 connected between the receiver 137 and the receiver capacitor 139 to pass the modulation frequency and reject other transient frequencies.

In certain embodiments, the temperature command signal can include at least one of temperature set point command or a data transmit command (e.g., to cause the local controller to send data back to the central controller 101). The temperature command signal can include an address code which addresses the temperature command signal to one or more of the heater control systems 123.

In certain embodiments, the local controller 125 can include a digital module that searches for the address code in the temperature command signal that corresponds to an associated heater 129 controlled by the local controller 123. The digital module can decode the temperature command signal if the address corresponds to the associated heater 129.

Each heater control system 123 can include a local voltage regulator 143 coupled between to the power line 107 and at least one of the local controller 125 or the sensor excitation source to convert power from the power line 107 to a useable form (e.g., to an appropriate DC voltage for the excitation source and/or the local controller 125 and/or to removing modulation from the signal).

The local controller 125 can be configured to transmit temperature sensor data back to the central control system 101 via the power line 107 using a local transmitter 145 to modulate the DC power on the power line 107 in a similar manner as described above. As shown, the local transmitter 145 can be connected to the power line 107 via a local transmit capacitor 147.

Using embodiments as describe above, a digitized local temperature can be compared to a commanded temperature. A control law, (e.g., a basic deadband law), can be used to determine the desired on or off state of the heater 129 implemented by the heater switch 127. Also, when commanded, the local controller 125 can transmit the local temperatures or any other suitable data back to the central controller 101 via the power line 107. The system 100 can support any suitable number if local heater control systems 123, heaters 129, temperature sensors, 131, and/or local controllers 125. For example, the power lines can be daisy chained from one heater control system 123 to the next.

Embodiments as described above allow for communication with one or more local heater control systems and/or components thereof via one or more power lines. This reduces the amount of weight, size, and/or complexity by eliminating many communication wires. For example, if implemented in an integrated circuit or hybrid circuit, the local heater controller package can be small and low mass.

The methods and systems of the present disclosure, as described above and shown in the drawings, provide for temperature control systems with superior properties including reduced size, weight, and complexity. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A temperature control system, comprising:
a central control system including:
a central controller that outputs a temperature command signal; and
a DC power source configured to output a DC power, wherein the central control system is configured to combine the DC power with temperature command signals to output a modulated power signal on a power line.

2. The system of claim 1, wherein the central control system further includes a data formatter operatively connected to the central controller and configured to convert the temperature command signal from the central controller to a serial digital format using a modulation frequency to create modulated serial data.

3. The system of claim 2, wherein the central control system further includes a reference clock operatively connected to the data formatter, wherein the modulation frequency is controlled by the reference clock.

4. The system of claim 3, wherein the central control system further includes a transmit amplifier coupled to the data formatter to output the temperature control command onto the power line via a transmit capacitor.

5. The system of claim 4, wherein the central control system further includes an isolation inductor disposed between the transmit capacitor and the DC power source for isolating the temperature command signal from the DC power source.

6. The system of claim 5, wherein the central control system further includes a receiving interface to receive data from the power line.

7. The system of claim 1, further including one or more heater control systems connected to the central control system via the power line, each heater control system including:
a local controller configured to receive the temperature command signal from the modulated signal; and
a heater switch controlled by the local controller to selectively electrically connect a heater to the power line, wherein the local controller controls the heater switch based on the temperature command signal.

8. The system of claim 7, wherein each heater control system includes one or more temperature sensors coupled to the local controller to provide temperature feedback to the local controller.

9. The system of claim 7, wherein the temperature command signal includes at least one of temperature set point command or a data transmit command.

10. The system of claim 7, wherein the temperature command signal includes an address code which addresses the temperature command signal to one or more of the heater control systems.

11. The system of claim 7, wherein each heater control system further includes a receiver that is disposed between the local controller and the power line, wherein the receiver is coupled to the power line via a receiver capacitor to receive the temperature command signal and output it to the local controller.

12. The system of claim 11, wherein each heater control system further includes a band pass filter connected between the receiver and the receiver capacitor to pass the modulation frequency and rejects other transient frequencies.

13. The system of claim 12, wherein the local controller includes a digital module that searches for the address in the temperature command signal that corresponds to an associated heater controlled by the local controller, wherein the digital module decodes the temperature command signal if the address corresponds to the associated heater.

14. The system of claim 8, wherein each heater control system includes a sensor excitation source and digitization electronics.

15. The system of claim 14, wherein each heater control system further includes a local voltage regulator coupled between to the power line and at least one of the local controller or the sensor excitation source to convert power from the power line to a useable form.

16. The system of claim 15, wherein the local controller is configured to transmit temperature sensor data back to the central control system via the power line using a local transmitter to modulate the DC power on the power line.

17. The system of claim 16, wherein the central control system includes a receiver interface including a receiver capacitor and a band pass filter disposed between the power line and the central controller to filter the temperature sensor data from the DC power.

18. A heater control system configured to be connected to a central control system via a power line, the heater control system including:
a local controller configured to receive a temperature command signal from a modulated signal on the power line; and
a heater switch controlled by the local controller to selectively electrically connect a heater to the power line, wherein the local controller controls the heater switch based on the temperature command signal.
